(19) United States
(12) Patent Application Publication
(10) Pub. No.: US 2016/0223922 A1
(43) Pub. Date: Aug. 4, 2016

(54) ELECTROPHOTOGRAPHIC PHOTOSENSITIVE MEMBER AND IMAGE FORMING APPARATUS USING SAME

(71) Applicant: FUJI ELECTRIC CO., LTD., Kawasaki-shi (JP)

(72) Inventors: Masaru TAKEUCHI, Matsumoto-city (JP); Ikuo TAKAKI, Matsumoto-city (JP); Shinjiro SUZUKI, Matsumoto-city (JP); Hiroshi EMORI, Matsumoto-city (JP)

(73) Assignee: FUJI ELECTRIC CO., LTD., Kawasaki-shi (JP)

(21) Appl. No.: 15/068,530

(22) Filed: Mar. 11, 2016

Related U.S. Application Data
(63) Continuation of application No. PCT/JP2014/068261, filed on Jul. 9, 2014.

(30) Foreign Application Priority Data
Feb. 24, 2014 (JP) 2014-033262

(51) Int. Cl. G03G 15/00

(52) U.S. Cl. CPC G03G 5/047

(57) ABSTRACT

An electrophotographic photosensitive member capable of preventing the occurrence of interference fringe patterns when the member is installed in a device using coherent light as exposure light, without exerting a negative influence on electric characteristics, is disclosed. The electrophotographic photosensitive member includes an electrically conductive substrate; a photosensitive layer provided on the electrically conductive substrate; and an intermediate layer interposed between the photosensitive layer and the electrically conductive substrate. The intermediate layer is composed of a cyanine dye having a maximum absorption wavelength within a range of exposure light source wavelength of ±50 nm; metal oxide fine particles; and a thermosetting resin as a binder resin. The photosensitive layer may be a laminated photosensitive layer including a charge generating layer and a charge transport layer. An image forming apparatus that includes the electrophotographic photosensitive member is also disclosed.

### CROSS-REFERENCE TO RELATED APPLICATION(S)

This non-provisional application for a U.S. patent is a Continuation of International Application PCT/JP2014/068261 filed Jul. 9, 2014, which claims priority from JP PA 2014-033262 filed Feb. 24, 2014, the entire contents of both of which are hereby incorporated by reference.

### BACKGROUND OF THE INVENTION

1. Field of the Invention

The present invention relates to an electrophotographic photosensitive member (referred to hereinbelow as “photosensitive member”) and an image forming apparatus using the same, and more particularly to the improvement of an electrophotographic photosensitive member for use in an electrophotographic-applied image-forming apparatus with coherent light as an exposure light source.

2. Background of the Related Art

Function-separated laminated organic photosensitive members of a negative charge type which are configured by successively laminating a charge generating layer and a charge transport layer on a conductive substrate (referred to hereinbelow simply as “substrate”) have been mainly used in recent years as electrophotographic photosensitive members for image forming apparatuses to which an electrophotographic method is applied, such as copiers, printers, and fax machines.

In such laminated photosensitive members, the charge generating layer laminated on the substrate is typically formed to be very thin so as to inject rapidly the charge carriers generated due to light absorption into the substrate and charge transport layer. Therefore, where scratches, contaminants, and adhered matter are present on the substrate surface, a uniform charge generating layer is difficult to form and film defects such as pinholes and film unevenness are formed causing image defects such a black spots and density unevenness. Another problem is that, since the ability to prevent the injection of charge carriers between the substrate and the charge generating layer is insufficient, the charge potential retention ratio of the photosensitive member is decreased by the charge carriers injected from the substrate, and background fogging appears on the white paper portions of the image.

In order to prevent the occurrence of such image defects, an intermediate layer mainly constituted by a resin such as a solvent-soluble polyamide, polyvinyl alcohol, polyvinyl butyral, and casein is provided between the substrate and photosensitive layer. From the standpoint of ability to prevent the injection of charge carriers, the intermediate layer using such resins is effective even in the form of a thin film with a thickness of about 0.1 μm or less, but in order to cover the defects or contaminants on the substrate surface and to address a problem of uneven film formation in a charge generating layer, a film thickness of 0.5 μm or more is required, and sometimes a film thickness of 1 μm or more is needed.

However, where an intermediate layer in the form of a thick film is interposed between the substrate and charge transport layer, the injectability of charge carriers, which are generated in the charge generating layer under light irradiation, into the substrate is degraded, a residual potential rises in repeated use, and image defects such as decrease in density can occur. To resolve this problem, materials for forming the intermediate layer have been intensively studied that exhibit a low electric resistance and small variations in electric resistance in spite of changes in surrounding environment even in the case of a thick-film layer. For example, solvent-soluble polyamide resins having a specific structure, cellulose derivatives, polyetherurethanes, polyvinyl pyrrolidone, and polyglycol ether have been suggested.

Meanwhile, when a photosensitive member using such an intermediate layer is installed in an electrophotographic-applied apparatus using coherent light as an exposure light source, for example, a laser beam printer, it is necessary to prevent the occurrence of image defects in the form of interference fringe patterns which occur due to the interference between the exposure light incident upon the photosensitive member and reflection light from the substrate surface which appears when the incident light reaches the substrate surface and is reflected there from. Such interference of the incident light and reflected light is related to the surface roughness of the substrate, refractive index and thickness of the photosensitive layer, and wavelength of the exposure light. Further, since the quantity of light reflected from the substrate typically decreases with increasing thickness of the intermediate layer, the interference fringe patterns are unlikely to occur.

This problem typically can be effectively resolved by adding an inorganic pigment filler to the intermediate layer. For example, a technique for adding finely powdered aluminum oxide and a technique for compounding a large amount of rutile-type titanium oxide with acryl melamine are well known, see Japanese Patent Application Publication No. H03-24558 (Patent Literature 1) and Japanese Patent Application Publication No. H02-67565 (Patent Literature 2). Further, Japanese Patent Application Publication No. H04-172361 (Patent Literature 3) indicates that anatase-type titanium oxide with a purity of 99% or higher is compounded with an underlayer (intermediate layer), and that from the standpoint of dispersibility and low resistance, anatase-type titanium oxide is preferred over rutile-type titanium oxide. However, where a filler is added to the intermediate layer in an amount necessary to prevent effectively the interference fringe pattern, the uniformity of the intermediate surface layer is lost, the injectability of charge carriers from the charge generating layer becomes uneven, and inconveniences such as decrease in image density and appearance of black spots on white paper can occur. A problem associated with a coating liquid for forming an intermediate layer in which a filler is dispersed is that the pot life of the coating liquid decreases due to precipitation and aggregation of the filler in the coating liquid.

Adding a material that absorbs the exposure light to the intermediate layer is another method for preventing the interference fringe pattern. For example, Japanese Patent Application Publication No. H02-82263 (Patent Literature 4) suggests decreasing the laser light transmittance of the intermediate layer to 40% or less by introducing a charge generating material into the intermediate layer. However, the following problems are associated with this method; thermally excited carriers generated by the charge generating material present in the intermediate layer cancel the surface charges, the potential retention capacity decreases, and background fogging appears on white paper, or the charge generating material serves as a carrier trap, the residual potential increases, and the image density is decreased.

A method of using metal oxide particles covered with a dye having an absorption maximum close to the exposure light wavelength in an intermediate layer including metal oxide particles and a method of using electrically conductive metal oxide powder in which a dye with light absorption within a range of 450 nm to 950 nm is arranged on the particle surface with an adhesive have been suggested as other methods for preventing the interference fringe pattern, see Japanese Patent Application Publication No. 2010-243984 (Patent Literature 5) and Japanese Patent Application Publication No. 2004-219904 (Patent Literature 6). However, the problems associated with those methods are that the coated dye is peeled off by mechanical stresses occurring during dispersion of the metal oxide particles when the coating liquid is fabricated, or metal oxide particles present in the coating liquid aggregate and precipitate due to poor compatibility of the coating dye and binding resin, thereby shortening the pot life of the coating liquid.

Yet another suggested method for preventing the interference fringe pattern involves introducing a dye or pigment with a molar absorption coefficient of 2.0×10⁵ lmol⁻¹ cm⁻¹ or more at an exposure light wavelength as a light absorbent in an underlayer, specifying the predetermined content ratio of the dye or pigment in the underlayer, transmittance of the exposure light in the underlayer, and reflectance of the exposure light at the interface of the underlayer with an upper layer which is contact therewith, and then providing the surface of the underlayer with a shape in which a plurality of protrusions satisfying the predetermined numerical expression stand close together, see Japanese Patent No. 5335366 (Patent Literature 7). However, with such a method, optical imprinting or thermal imprinting is preferred from the standpoint of production efficiency for forming the shape in which a plurality of protrusions stand close together on the underlayer surface, and thermal imprinting is particularly preferred, but in the case of thermal imprinting it is preferred that the resin constituting the underlayer be a thermoplastic resin, see Patent Literature 7, paragraphs [0054] to [0056]. Where a thermoplastic resin is thus used for the underlayer, when a charge generating layer is formed on the underlayer, the thermoplastic resin used for the underlayer is swelled by the solvent which is used for the coating liquid for forming the charge generating layer. As a result, the dye or pigment present in the underlayer is eluted into the charge generating layer, the dye or pigment becomes a carrier trap, a decrease in sensitivity or a residual potential increase occurs, and the image density is decreased.

Inducing scattering of the reflected light by machining the substrate surface is also an effective method for preventing interference fringe patterns, but since the number of manufacturing steps increases, the substrate cost rises. Further, due to a spread in machining, this method is insufficient for preventing the interference fringe pattern.

Meanwhile, a technique for providing an intermediate layer including a dye that absorbs the exposure light between a support member and a photosensitive layer is also known for adjusting the sensitivity by adjusting the amount of reflected exposure light from the support member, see Japanese Patent Application Publication No. 2004-37833 (Patent Literature 8). However, in this case, the electric resistance is high and charge carrier blocking ability increases. As a result, the injectability of charge carriers, which have been generated in the charge generating layer under light irradiation, into the substrate is degraded, the residual potential rises, and image defects, such as decrease in density, occur.

A technique for introducing an IR-absorbing dye into a protective layer laminated on a photosensitive layer surface so that the transmittance of the protective layer with respect to a monochromatic light with a wavelength of 780 nm is 90% or less has been suggested for adjusting the light attenuation characteristic to the desired level, without degrading the properties required for the photosensitive member, see Japanese Patent Application Publication No. H06-123993 (Patent Literature 9). However, in this case, only the quantity of exposure light incident on a layer of the photosensitive member below the protective layer is reduced and the relative quantity of exposure light reflected from the substrate is not changed. Therefore, this technique does not prevent interference fringe patterns.

As mentioned hereinabove, various techniques have been suggested, but they are all insufficient, and a technique capable of preventing the occurrence of interference fringe patterns when using coherent light as exposure light, without affecting the electric characteristics of the photosensitive member, has not yet been established.

Accordingly, it is an objective of the present invention to provide an electrophotographic photosensitive member capable of preventing the occurrence of interference fringe patterns when the member is installed in a device using coherent light as exposure light, without affecting the electric characteristics, and also provide an image forming apparatus using the electrophotographic photosensitive member.

### SUMMARY OF THE INVENTION

The inventors have conducted a comprehensive study aimed at the resolution of the abovementioned problems. The results obtained demonstrated that the abovementioned problems can be resolved by introducing a specific cyanine dye and metal oxide fine particles and using a thermosetting resin as a binder resin in the intermediate layer of a photosensitive member.

Thus, the electrophotographic photosensitive member in accordance with the present invention has a photosensitive layer on an electrically conductive substrate, with an intermediate layer being interposed between the photosensitive layer and the conductive substrate, wherein the intermediate layer includes a cyanine dye having a maximum absorption wavelength within a range of exposure light source wavelength ±50 nm, metal oxide fine particles, and a thermosetting resin as a binder resin.

In the photosensitive member in accordance with the present invention, it is preferred that when the exposure light source wavelength is 780 nm, the maximum absorption wavelength of the cyanine dye be within a range of 780 nm±50 nm.

Further, in the photosensitive member in accordance with the present invention, it is preferred that when the exposure light source wavelength is 780 nm, a reflectance of light with a wavelength of 780 nm on a surface of the intermediate layer be 30% or less. It is also preferred that in the photosensitive member in accordance with the present invention, the photosensitive layer be a laminated photosensitive layer constituted by a charge generating layer and a charge transport layer.

Further, the image forming apparatus in accordance with the present invention includes an electrophotographic photosensitive member, charging means, exposure means, development means, and transfer means, wherein the exposure means has a light source emitting coherent light, the electrophotographic photosensitive member is provided with a photosensitive layer on an electrically conductive substrate, with an intermediate layer being interposed between the photosensitive layer and the conductive substrate, and the intermediate layer includes a cyanine dye having a maximum absorption wavelength within a range of exposure light source wavelength ±50 nm, metal oxide fine particles, and a thermosetting resin as a binder resin.

The present invention makes it possible to realize an electrophotographic photosensitive member capable of preventing the occurrence of interference fringe patterns when the member is installed in a device using coherent light as exposure light, without affecting the electric characteristics, and also an image forming apparatus using the electrophotographic photosensitive member.

### BRIEF DESCRIPTION OF THE DRAWINGS

FIG. 1 is a schematic cross-sectional view illustrating an example of the laminated electrophotographic photosensitive member in accordance with the present invention; and

FIG. 2 is a schematic configuration diagram illustrating an example of the image forming apparatus in accordance with the present invention.

### DETAILED DESCRIPTION OF THE INVENTION

Specific embodiments of the electrophotographic photosensitive member in accordance with the present invention will be explained hereinbelow in greater detail with reference to the drawings.

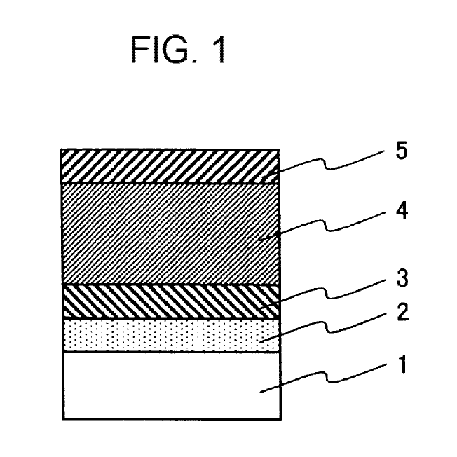

FIG. 1 is a schematic cross-sectional view illustrating an example of the laminated electrophotographic photosensitive member in accordance with the present invention. The photosensitive member depicted in the figure has a configuration in which a photosensitive layer constituted by a charge generating layer 3 and a charge transport layer 4 is provided on an electrically conductive substrate 1, with an intermediate layer 2 being interposed therebetween. A protective layer 5 is not required in the present invention, but may be provided as necessary.

In the photosensitive member in accordance with the present invention, it is important that the intermediate layer 2 formed on the electrically conductive substrate 1 include a cyanine dye having a maximum absorption wavelength within a range of exposure light source wavelength ±50 nm, metal oxide fine particles, and a thermosetting resin as a binder resin. As a result it is possible to prevent the occurrence of interference fringe pattern when the photosensitive member is installed in an apparatus using coherent light as exposure light and ensure good image quality, without affecting the electrical characteristics as in the conventional configuration. The present invention is particularly useful in the case of a laminated photosensitive member which is a laminated photosensitive layer in which the photosensitive layer includes the charge generating layer 3 and the charge transport layer 4.

The mechanism for preventing the occurrence of interference fringe pattern even when coherent light is used as exposure light in the photosensitive member in accordance with the present invention is explained hereinbelow. That is, in the photosensitive member in accordance with the present invention, the exposure light which has reached the intermediate layer is randomly reflected by the metal oxide fine particles, which are present in the intermediate layer, and absorbed by the cyanine dye demonstrating absorption in the exposure light wavelength range, thereby making it possible to reduce the quantity of the exposure light that reaches the substrate surface and is reflected by the substrate surface, such reflection causing an interference fringe pattern. In accordance with the present invention, by using the metal oxide fine particles together with the cyanine dye in the intermediate layer, it is possible to obtain the desired effect without causing image defects or shortening the pot life which occurs when a filler is used in a large amount and also without degrading the image quality which occurs when a dye is used alone.

Further, in accordance with the present invention, as a result of using a thermosetting resin as a binder resin for the intermediate layer, the ingredients such as the cyanine dye are constrained in the three-dimensional mesh structure of the resin subjected to thermosetting, thereby preventing the problem associated with the elution of the ingredients, such as the cyanine dye, which are contained in the intermediate layer, which occurs when a coating liquid for forming the charge generating layer is formed by coating on the upper layer of the intermediate layer. Thus, in accordance with the present invention it is possible to obtain a photosensitive member that excels in productivity, without any other problems or without the occurrence of an interference fringe pattern. Another effect that can be obtained with the present invention is that by using a combination of the cyanine dye, metal oxide fine particles, and thermosetting resin, it is possible to reduce a residual potential in electric characteristics, although the mechanism leading to this effect is not clear. Yet another merit of the photosensitive member in accordance with the present invention is that since the invention relates to the improvement of the intermediate layer, the degree of freedom in designing the photosensitive layers is high.

Any cyanine dye which satisfies the requirement relating to the maximum absorption wavelength and has a cyanine structure can be used as the cyanine structure with a maximum absorption wavelength within a range of exposure light source wavelength ±50 nm, which is used in accordance with the present invention. In particular, it is preferred that a cyanine dye be used which has a molar absorption coefficient at 780 nm of 2.0×10⁵ L/mol·cm or more. When the exposure light source wavelength (nm) is 780 nm, the maximum absorption wavelength of such a cyanine dye can be set within a range of 780±50 nm. Thus, the photosensitive member in accordance with the present invention can be advantageously used in an image forming apparatus with an exposure light source wavelength of 780 nm.

Further, examples of metal oxide fine particles that are used in accordance with the present invention include metal oxide fine particles such as titanium oxide, silicon oxide, zinc oxide, calcium oxide, aluminum oxide, and zirconium oxide which have been surface treated, as desired, with aminosilanes or alkylsilanes, metal sulfate fine particles such as barium sulfate and calcium sulfate, metal nitride fine particles such as silicon nitride and aluminum nitride, organometallic compounds, silane coupling agents, and particles formed from organometallic compounds and silane coupling agents, and the preferred fine particles can be selected and used from the standpoint of refractive index, surface resistance, type of surface treatment (contributes to the dispersivity with the binder resin which is to be used in combination therewith), and coverage ratio thereof (contributes to adjustment or resistance value and dispersivity of metal oxide fine particles). Those metal oxide fine particles can be used individually or in appropriate combinations of two or more thereof, within a range in which the effect of the present invention is not significantly lost. The particle size of the metal oxide fine particles used in accordance with the present invention is not particularly limited, and for example, particles with an average particle diameter of 10 nm to 400 nm can be used.

Further, one resin selected from resole phenolic resins, urea resins, melamine resins, guanamine resins, silicone resins, unsaturated polyester resins, alkyd resins, diallylphthalate resins, epoxy resins, polybutadiene resins, urethane resins, and thermosetting polyamide resins, or an appropriate combination of two or more of such resins can be used as the thermosetting resin which is used as the binder resin in the intermediate layer in accordance with the present invention.

The compounded amount of the cyanine dye in the intermediate layer is preferably 0.1 mass % to 5 mass %, more preferably 0.3 mass % to 3 mass % with respect to solids in the intermediate layer. Where the compounded amount of the cyanine dye is too small, the occurrence of interference fringe pattern cannot be sufficiently prevented, and where the compounded amount is too large, the cyanine dye remains undissolved in the coating liquid and the intermediate layer cannot be formed, each of those results being undesirable. Further, the compounded amount of the metal oxide fine particles is preferably 30 mass % to 90 mass %, more preferably 50 mass % to 80 mass % with respect to solids in the intermediate layer. Where the compounded amount of the metal oxide fine particles is too small, the occurrence of interference fringe pattern cannot be sufficiently prevented, and where the compounded amount is too large, the uniformity of the intermediate layer surface is lost and image defects can occur, each of those results being undesirable.

Further, the intermediate layer may include, as necessary, a crosslinking agent for enhancing the crosslinking reaction of the thermosetting resin. The crosslinking agent is not particularly limited, and an advantageous compound can be used, as appropriate, within a range in which the effect of the present invention is not significantly affected. Further, if necessary, other well-known additive can be also included within ranges in which the expected effect of the present invention is not significantly affected.

In the present invention, it is preferred that when the exposure light source wavelength is 780 nm, the reflectance of light with a wavelength of 780 nm on the surface of the intermediate layer is 30% or less, more preferably 20% or less, and the lower the better. As the reflectance decreases, the effect of suppressing the interference fringe pattern can be increased.

In accordance with the present invention, the coating liquid which is used to form the intermediate layer is prepared by dispersing metal oxide fine particles in the solution of the thermosetting resin serving as a binder resin and dissolving the cyanine dye. A generally used device such as a vibration mill, a paint shaker, or a sand grinder can be used for dispersing, and it is preferred that zirconia be used as the dispersion medium because a more homogenous dispersion can be prepared.

The intermediate layer can be formed by coating the coating liquid prepared in the above-described manner on the surface of an electrically conductive substrate by the usual method and then drying. Well-known methods such as a dip coating method, doctor blade method, bar coating method, roll transfer method, and spraying method can be used for coating the coating liquid, but when coating is performed on a cylindrical substrate, it is preferred that the dip coating method be used. The thickness of the intermediate layer depends on the composition of the intermediate layer, but can be arbitrarily set within a range in which no adverse effect, such as an increase in residual potential, is produced when the photosensitive member is used repeatedly in a continuous manner, the preferred thickness being from 0.3 μm to 30 μm. The intermediate layer may be in the form of a single layer, or may be a laminate including two or more different layers. In this case, it is not necessary that all of the layers include the cyanine dye, metal oxide fine particles, and the thermosetting resin. For example, a configuration may be used in which an intermediate layer constituted by an alcohol-soluble nylon as a thermoplastic resin is laminated on an intermediate layer including the cyanine dye, metal oxide fine particles, and the thermosetting resin.

In accordance with the present invention, the electrically conductive substrate 1 acts as an electrode of the photosensitive member and, at the same time, as a support for other layers. This substrate may have a cylindrical, plate-like, or film-like shape, but typically has a cylindrical shape. Metals such as well-known aluminum alloys conforming to JIS3003, JIS5000, and JIS6000 series, stainless steel, and nickel, and also glass or resin treated to have an electrically conductive surface can be used as the substrate material.

When the substrate is fabricated from an aluminum alloy, the substrate can be finished to the predetermined dimensional accuracy by extrusion or drawing, and when the substrate is fabricated from a resin, the substrate can be finished to the predetermined dimensional accuracy by injection molding. If necessary, the substrate surface can be processed to an appropriate surface roughness by cutting with a diamond bite or the like. Then, degreasing and washing can be performed by using an aqueous detergent such as a weakly alkaline detergent to wash the substrate surface, and the intermediate layer can be thereafter provided on the surface of the washed substrate.

The charge generating layer 3 is formed by coating on the intermediate layer 2 a coating liquid prepared by dispersing or dissolving particles of a charge generating material in a binder resin, and electric charges are generated by receiving light. The charge generating material is not particularly limited, provided that it is a material having photosensitivity to the wavelength of the exposure light source. Examples of suitable materials include organic pigments such as phthalocyanine pigments, azo pigments, quinacridone pigments, indigo pigments, perylene pigments, polycyclic quinone pigments, anthanthrone pigments, and benzimidazole pigments. For example, a polyester resin, a polyvinylacetal resin, a polymethacrylic acid ester resin, a polycarbonate resin, a polyvinyl butyral resin, and a phenoxy resin can be used individually or in appropriate combinations as the binder resin for the charge generating layer. The content ratio of the charge generating material in the charge generating layer is preferably 20 mass % to 80 mass %, more preferably 30 mass % to 70 mass % with respect to the solid fraction in the charge generating layer. The thickness of the charge generating layer is usually 0.1 μm to 0.6 μm.

The charge transport layer 4 is mainly constituted by the charge transport material and binder resin. For example, an enamine-type compound, a styryl-type compound, an amine-type compound, and a butadiene-type compound can be used as the charge transport material. The binder resin for the charge transport layer preferably has good miscibility with the charge transport material. For example, a polyester resin, a polycarbonate resin, a polymethacrylic acid ester resin, and a polystyrene resin can be used individually or in appropriate combinations as the binder resin. The charge transport layer is formed by dissolving the charge transport material together with the binder resin in an appropriate solvent, optionally adding an antioxidant, a UV-absorber, and a leveling agent to prepare a coating liquid, coating the coating liquid on the charge generating layer, and drying. The content ratio of the charge transport material in the charge transport layer is 20 mass % to 60 mass %, preferably 25 mass % to 50 mass % with respect to the solid fraction in the charge transport layer. The thickness of the charge transport layer is usually 10 μm to 40 μm.

The protective layer 5 can be provided, as necessary, to increase printing resistance. The protective layer 5 is constituted by a layer including a binder resin as the main component, or by an inorganic thin film such as amorphous carbon. Fine particles of a metal oxide such as silicon oxide, titanium oxide, zinc oxide, calcium oxide, aluminum oxide, and zirconium oxide, a metal sulfate such as barium sulfate and calcium sulfate, and a metal nitride such as silicon nitride and aluminum nitride, or particles of a fluororesin such as a tetrafluoroethylene resin and a fluorine-containing comb-type graft polymer resin may be also introduced in the binder resin with the object of increasing electric conductivity, reducing friction coefficient, and imparting lubricity.

Further, with the object of imparting charge transport ability, the protective layer can include a hole transport substance or an electron transport substance which is used in the charge generating layer and charge transport layer, and with the object of improving leveling ability and imparting lubricity of the film which has been formed, the protective layer can include a leveling agent such as fluorine oil or silicone oil. If necessary, other well-known additives can be included within ranges in which the electrophotographic property is not significantly degraded.

Described hereinabove is the laminated photosensitive member, but the present invention can be also used in a single-layer photosensitive member in which a single-layer photosensitive layer combining the charge generation and charge transport functions is provided on the electrically conductive substrate 1, with the intermediate layer 2 being interposed therebetween. The electrically conductive substrate 1 and the intermediate layer 2 in the single-layer photosensitive member are configured in the same manner as in the above-described laminated photosensitive member. Further, the single-layer photosensitive layer can be configured by the usual method by using a charge generating material, an electron transport material, a hole transport material, and a binder resin as the main components.

The expected effect of the photosensitive member in accordance with the present invention can be obtained in applications to a variety of machine processes. More specifically, sufficient effects can be obtained in a charging process performed by a contact charging method using a roller or brush and a contactless charging method using a corotron or scorotron, and a development process performed by a contactless development method or a contact development method using a development system with a nonmagnetic single component or magnetic single component or two components.

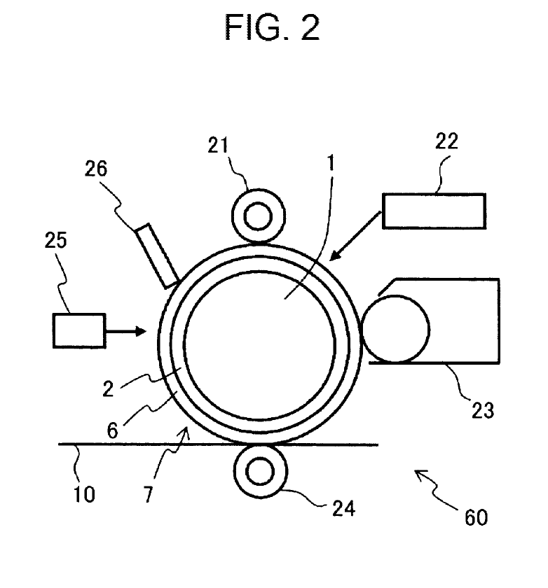

FIG. 2 is a schematic configuration diagram illustrating an example of the image forming apparatus in accordance with the present invention. An image forming apparatus 60 in accordance with the present invention, which is depicted in the figure, is provided with the photosensitive member 7 in which the photosensitive layer 6 is formed on the electrically conductive substrate 1, with the intermediate layer 2 being interposed there between. The image forming apparatus 60 is constituted at least by a charging roller (charging means) 21, an exposure laser optical system (exposure means) 22, a development unit (development means) 23, and a transfer roller (transfer means) 24 which are arranged at the outer circumference of the photosensitive member 7. A charging brush, a corotron, and a scorotron may be used, in addition to the charging roller, as the charging means. A gas laser, a semiconductor laser, and a LED can be used, in addition to a halogen lamp, as an exposure light source of the exposure means. The image forming apparatus 60 may be also provided, as depicted in the figure, with a charge removing device 25 and a cleaning blade 26. The reference numeral 10 in the figure denotes a paper sheet as a transfer member. The image forming apparatus 60 can also be a color printer.

In the image forming apparatus in accordance with the present invention, the exposure laser optical system 22 serving as the exposure means has a light source emitting coherent light, and the installed photosensitive member 7 is provided with the intermediate layer 2 including the above-described specific cyanine dye, metal oxide fine particles, and thermosetting resin. As a result, the interference fringes that can be caused by interference of the exposure light and the reflected light from the substrate surface under irradiation with the interferable exposure light can be effectively prevented.

### EXAMPLES

The present invention will be explained hereinbelow in detail on the basis of examples thereof. The present invention is not limited to the description of those example and may be variously changed without departing from the essence thereof.

### Example 1

A cyanine dye (trade name IR-780 iodide, λmax=780 nm, manufactured by Sigma-Aldrich Co.) was added in addition to 15 parts by mass of a p-vinylphenolic resin (trade name Maruka Lyncur MH-2, manufactured by Maruzen Petrochemical Co., Ltd.) and 10 parts by mass of an n-butylated melamine resin (trade name Yuban 2021, manufactured by Mitsui Chemicals, Inc.) as binder resins and 75 parts by mass of titanium oxide fine particles (average particle size approximately 30 nm) subjected to aminosilane treatment as a filler, so as to obtain 1 mass % with respect to the solids of the intermediate layer, and those components were dissolved and dispersed in a mixed solvent including methanol and butanol at a ratio of 120 parts by mass/30 parts by mass to prepare a coating liquid for forming the intermediate layer. An aluminum alloy cylindrical substrate with an outer diameter of 30 mm and a length of 260 mm was immersed into the coating liquid and then pulled up to form a coating film on the outer circumference of the substrate. The substrate was dried for 30 min at a temperature of 140° C., and the intermediate layer with a thickness of 3 μm after drying was formed.

The reflectance of light with a wavelength of 780 nm on the intermediate layer surface was measured, prior to forming a charge generating layer, under the below-described conditions with an instantaneous multiple photometric system MCPD-3000 manufactured by Otsuka Electronics Co., Ltd. The result demonstrated that the reflectance was 17.4%.

### Measurement Conditions for Light Reflectance

Measurement mode: relative reflection;

Reference: aluminum alloy substrate;

Exposure time: 100 msec;

Amplification gain: NORMAL;

Number of integration cycles: one; and

Slit: 0.1×2 mm.

Further, another substrate on which the intermediate layer was formed in the same manner and the charge generating layer has not yet been formed was immersed for 60 sec into dichloromethane which was a solvent used in the coating liquid for forming the charge generating layer, the coloration of the solvent after the immersion was visually checked, and elution of the cyanine dye from the intermediate layer was estimated. As a result, no elution of the cyanine dye was observed. In the estimation results on dye elution, the symbols ◯ and X were used to denote cases without and with elution, respectively.

Then, the coating liquid for forming the charge generating layer was prepared by dispersing 15 parts by mass of Y-type titanyl phthalocyanine disclosed in Japanese Patent Application Publication No. S64-17066 as a charge generating material and 15 parts by mass of polyvinyl butyral (trade name S-Lec B BX-1, manufactured by Sekisui Chemical Co., Ltd.) as a binder resin in 600 parts by mass of dichloromethane and dispersing for 1 hour with a sand mill disperser. The coating liquid was coated on the above-described intermediate layer and dried for 30 min at a temperature of 80° C. to obtain a charge generating layer with a thickness of 0.3 μm after drying.

A coating liquid for forming the charge transport layer was then prepared by dissolving 100 parts by mass of the compound represented by the structural formula (CT1) below as a charge transport material and 100 parts by mass of a polycarbonate resin (trade name lupizeta PCZ-500, manufactured by Mitsubishi Gas Chemical Co., Inc.) in 900 parts by mass of dichloromethane and then adding 0.1 part by mass of silicone oil (trade name KP-340, manufactured by Shin-Etsu Chemical Co., Ltd.). The coating liquid was coated to form a film on the charge generating layer and dried for 60 min at a temperature of 90° C. to form the charge transport layer with a thickness of 25 μm after drying. An electrophotographic photosensitive member was thus fabricated.

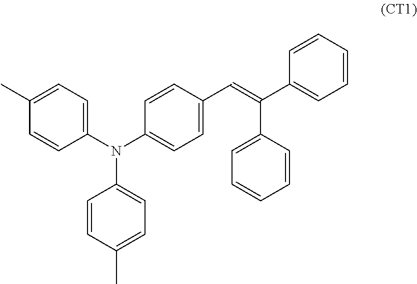 [SMILES: Cc1ccc(N(c2ccc(C)cc2)c2ccc(C=C(c3ccccc3)c3ccccc3)cc2)cc1]

### Examples 2 to 10 and Comparative Examples 1 to 3

The intermediate layers were formed, the reflectance of the intermediate layers was evaluated, and elution of the dyes was estimated, and the photosensitive members were fabricated in the same manner as in Example 1, except that the cyanine dye used in the intermediate layer (trade name IR-780 iodide, λmax=780 nm, manufactured by Sigma-Aldrich Co.) and the content ratio of 1 mass % thereof were changed to the dyes and amounts thereof which are presented in Table 1.

TABLE 1

| | | | | Amount |
|---|---|---|---|---|
| | | | | added |
| | Dye | | λmax | (mass |
| | Name (trade name) | Manufacturer | (nm) | %) |
| Example 1 | IR-780 iodide | Sigma-Aldrich Co. | 780 | 1 |
| Example 2 | 1,1′,3,3,3′,3′- | Sigma-Aldrich Co. | 740 | 1 |
| | hexameth- | | | |
| | ylindotricarbocya- | | | |
| | nine iodide | | | |
| Example 3 | IR-775 chloride | Sigma-Aldrich Co. | 775 | 1 |
| Example 4 | IR-783 | Sigma-Aldrich Co. | 782 | 1 |
| Example 5 | IR-806 | Sigma-Aldrich Co. | 806 | 1 |
| Example 6 | IR-820 | Sigma-Aldrich Co. | 820 | 1 |
| Example 7 | Indocyanine Green | Tokyo Kasei Kogyo | 787 | 1 |
| | | KK | | |
| Example 8 | KAYASORBCY-10 | Nippon Kayaku KK | 781 | 1 |
| Example 9 | IR-780 iodide | Sigma-Aldrich Co. | 780 | 0.3 |
| Example 10 | IR-780 iodide | Sigma-Aldrich Co. | 780 | 3 |
| Comparative | — | — | — | — |
| Example 1 | | | | |
| Comparative | 1,1′-Diethyl-2,2′- | Sigma-Aldrich Co. | 707 | 0.4 |
| Example 2 | dicarbocyanine | | | |
| | iodide | | | |
| Comparative | IR-895 | Sigma-Aldrich Co. | 895 | 0.4 |
| Example 3 | | | | |

### Example 11

A cyanine dye (trade name IR-780 iodide, λmax=780 nm, manufactured by Sigma-Aldrich Co.) was added in addition to 20 parts by mass of a polyester resin (trade name Beckolite M-6401-50, manufactured by DIC Corp.) and 5 parts by mass of an n-butylated melamine resin (trade name Yuban 20SB, manufactured by Mitsui Chemicals, Inc.) as binder resins and 75 parts by mass of titanium oxide fine particles subjected to alkylsilane treatment (trade name JMT-1501B, manufactured by Tayca Corp.) as a filler, so as to obtain 1 mass % with respect to the solids of the intermediate layer, and those components were dissolved and dispersed in 230 parts by mass of methyl ethyl ketone to prepare a coating liquid for forming the intermediate layer. An aluminum alloy cylindrical substrate with an outer diameter of 30 mm and a length of 260 mm was immersed into the coating liquid and then pulled up to form a coating film on the outer circumference of the substrate. The substrate was dried for 30 min at a temperature of 140° C., and the intermediate layer with a thickness of 3 μm after drying was formed. The reflectance of the intermediate layers was evaluated, and elution of the dyes was estimated, and the photosensitive member was fabricated in the same manner as in Example 1.

### Comparative Example 4

The intermediate layer was formed, the reflectance of the intermediate layer was evaluated, and elution of the dye was estimated, and the photosensitive member was fabricated in the same manner as in Example 1, except that alcohol-soluble nylon (trade name Amylan CM8000, manufactured by Toray Industries, Inc.), which is a thermoplastic resin, was used instead of 15 parts by mass of a p-vinylphenolic resin (trade name Maruka Lyncur MH-2, manufactured by Maruzen Petrochemical Co., Ltd.) and 10 parts by mass of an n-butylated melamine resin (trade name Yuban 2021, manufactured by Mitsui Chemicals, Inc.) as a binder resin used in the intermediate layer.

### Comparative Example 5

A cyanine dye (trade name IR-780 iodide, λmax=780 nm, manufactured by Sigma-Aldrich Co.) was added in addition to 15 parts by mass of a p-vinylphenolic resin (trade name Maruka Lyncur MH-2, manufactured by Maruzen Petrochemical Co., Ltd.) and 10 parts by mass of an n-butylated melamine resin (trade name Yuban 2021, manufactured by Mitsui Chemicals, Inc.) as binder resins, so as to obtain 1 mass % with respect to the solids of the intermediate layer, and those components were dissolved in a mixed solvent including methanol and butanol at a ratio of 750 parts by mass/150 parts by mass to prepare a coating liquid for forming the intermediate layer. An aluminum alloy cylindrical substrate with an outer diameter of 30 mm and a length of 260 mm was immersed into the coating liquid and then pulled up to form a coating film on the outer circumference of the substrate. The substrate was dried for 30 min at a temperature of 140° C., and the intermediate layer with a thickness of 0.5 μm after drying was formed. The reflectance of the intermediate layers was evaluated, and elution of the dyes was estimated, and the photosensitive member was fabricated in the same manner as in Example 1.

Electric characteristics of the photosensitive members fabricated in Examples 1 to 11 and Comparative Examples 1 to 5 and the presence/absence of an interference fringe pattern on the half-tone image were evaluated by the following methods.

### Evaluation of Electric Characteristics

Electric characteristics of the photoelectric members were evaluated by the following method by using a photosensitive member electric property test machine CYNTHIA91 FE (manufactured by Gentec Co.) under an environment with a temperature of 23° C. and a relative humidity of 50%. Initially, the surface of the photosensitive member was changed to −800 V by a corona discharge in a dark room, and then the surface potential V0 immediately after the charging as measured. After the photosensitive body has been allowed to stay for 5 sec in the dark room, the surface potential V5 was measured, and the potential retention ratio Vk5 after 5 sec after the charging was determined from the following Expression (1),

Vk5=V5/V0×100 (1).

A halogen lamp was then used as a light source, successive exposure was performed by using monochromatic light dispersed to 780 nm with a band-pass filter and varying the exposure quantity from the point of time at which the surface potential became −800 V, the surface potential at this time was measured, the exposure quantity required to obtain the surface potential of −100 V was determined as the sensitivity E100 (μJ/cm²) from the obtained light attenuation curve, and the surface potential at the time of irradiation at an exposure quantity of 1 μJ/cm² was determined as a residual potential Vr (−V).

### Image Evaluation

Each photosensitive member was installed on a commercial semiconductor laser beam printer of a nonmagnetic single-component development system, and printing of a half-tone image was performed under an environment with a temperature of 23° C. and a relative humidity of 50%. Symbols ◯ and X were used to represent the cases without and with interference fringes, respectively. The results are shown in Table 2.

TABLE 2

| | | | | | | Image |
|---|---|---|---|---|---|---|
| | | | | | | evaluation |
| | | | Evaluation of | | | Interference |
| | Reflec- | | electric characteristics | | | fringe |
| | tance | n of | Vk5 | E100 | Vr | patterns on |
| | (%) | dye | (%) | (μJ/cm²) | (−V) | halftone image |
| Example 1 | 17.4 | ∘ | 93.0 | 0.56 | 30 | ∘ |
| Example 2 | 25.4 | ∘ | 92.4 | 0.65 | 48 | ∘ |
| Example 3 | 17.6 | ∘ | 93.3 | 0.62 | 35 | ∘ |
| Example 4 | 17.5 | ∘ | 92.8 | 0.59 | 25 | ∘ |
| Example 5 | 17.7 | ∘ | 92.0 | 0.61 | 29 | ∘ |
| Example 6 | 18.0 | ∘ | 92.8 | 0.64 | 33 | ∘ |
| Example 7 | 17.5 | ∘ | 92.3 | 0.59 | 31 | ∘ |
| Example 8 | 16.6 | ∘ | 93.8 | 0.62 | 45 | ∘ |
| Example 9 | 19.2 | ∘ | 92.6 | 0.58 | 38 | ∘ |
| Example 10 | 17.2 | ∘ | 92.1 | 0.55 | 26 | ∘ |
| Example 11 | 18.1 | ∘ | 94.1 | 0.59 | 32 | ∘ |
| Comparative | 57.2 | ∘ | 94.1 | 0.68 | 50 | x |
| Example 1 | | | | | | |
| Comparative | 42.5 | ∘ | 91.5 | 0.58 | 40 | x |
| Example 2 | | | | | | |
| Comparative | 38.7 | ∘ | 90.2 | 0.69 | 52 | x |
| Example 3 | | | | | | |
| Comparative | 19.3 | x | 87.8 | 0.73 | 68 | ∘ |
| Example 4 | | | | | | |
| Comparative | 70.1 | ∘ | 85.4 | Cannot be | 165 | x |
| Example 5 | | | | measured | | |

The results presented in the table confirm that the occurrence of the interference fringe pattern on the half-tone image can be prevented without causing problems with the electric characteristics, such as increase in residual potential, by introducing the specific cyanine dye together with metal oxide fine particles and a thermosetting resin as a binder resin into the intermediate layer.

By contrast, in Comparative Example 1, in which no cyanine dye was added to the intermediate layer, the reflectance of light with a wavelength of 780 nm at the intermediate layer surface was high and the interference fringe pattern appeared on the half-tone image. Further, in Comparative Examples 2 and 3 which used cyanine dyes that did not satisfy the condition of a maximum absorption wavelength, the reflectance of light with a wavelength of 780 nm at the intermediate surface was high and the interference fringe pattern appeared on the half-tone image.

Furthermore, in Comparative Example 4 in which alcohol-soluble nylon, which is a thermoplastic resin, was used instead of the thermosetting resin as a binder resin, the cyanine dye was confirmed to elute into dichloromethane which was used as a solvent for the coating liquid for forming the charge generating layer which was the upper layer of the intermediate layer. Along with this, the degradation of electric characteristic, such as decrease in sensitivity and increase in residual potential, was also confirmed. This was apparently because the cyanine dye which has eluted into the charge generating layer became a carrier trap.

Further, in Comparative Example 5, in which the intermediate layer did not include the metal oxide fine particles, the reflectance of light with a wavelength of 780 nm at the intermediate surface was high, the interference fringe pattern appeared on the half-tone image, and the degradation of electric characteristic, such as decrease in sensitivity and increase in residual potential, was also confirmed. This was apparently because the electric resistance of the intermediate layer was high, and the injectability of charge carriers, which have been generated in the charge generating layer, into the substrate has degraded.

The comparison of the above-described examples and comparative examples, clearly demonstrate the effect produced by providing the intermediate layer in accordance with the present invention which includes a cyanine dye having a maximum absorption wavelength within a range of exposure light source wavelength ±50 nm, metal oxide fine particles, and a thermosetting resin as a binder resin.

What is claimed is:

1. An electrophotographic photosensitive member, comprising:
an electrically conductive substrate;
a photosensitive layer provided on the electrically conductive substrate; and
an intermediate layer interposed between the photosensitive layer and the electrically conductive substrate, and being comprised of a cyanine dye having a maximum absorption wavelength within a range of exposure light source wavelength ±50 nm; metal oxide fine particles; and a binder resin that is a thermosetting resin.

2. The electrophotographic photosensitive member according to claim 1, wherein the maximum absorption wavelength of the cyanine dye is within a range of exposure light source wavelength of 780 nm±50 nm.

3. The electrophotographic photosensitive member according to claim 2, wherein the intermediate layer has a surface having a reflectance of light of wavelength of 780 nm that is 30% or less.

4. The electrophotographic photosensitive member according to claim 1, wherein the photosensitive layer is a laminated photosensitive layer comprised of a charge generating layer and a charge transport layer.

5. An image forming apparatus, comprising:
an electrophotographic photosensitive member comprised of an electrically conductive substrate; a photosensitive layer provided on the electrically conductive substrate; and an intermediate layer interposed between the photosensitive layer and the electrically conductive substrate;
charging means;
exposure means including a light source that emits coherent light;
development means; and
transfer means,
wherein the intermediate layer is comprised of:
a cyanine dye having a maximum absorption wavelength within a range of exposure light source wavelength of ±50 nm;
metal oxide fine particles; and
a thermosetting resin as a binder resin.

6. An electrophotographic photosensitive member, comprising:
an electrically conductive substrate;
a photosensitive layer provided on the electrically conductive substrate; and
an intermediate layer interposed between the photosensitive layer and the electrically conductive substrate, and being comprised of a cyanine dye having a maximum absorption wavelength within a range of exposure light source wavelength ±50 nm; metal oxide particles; and a binder resin.
